(19) United States
(12) Patent Application Publication
(10) Pub. No.: US 2011/0064112 A1
(43) Pub. Date: Mar. 17, 2011

(54) SOLID-STATE LASER WITH WAVEGUIDE PUMP PATH (Z PUMP)

(75) Inventors: Alexandre Oumiskov, Moscow (RU); Serge Khorev, Singapore (SG); Abdelmounaime Faouzi Zerrouk, Singapore (SG)

(73) Assignee: ZECOTEK LASER SYSTEMS, INC., Singapore (SG)

(21) Appl. No.: 12/881,033

(22) Filed: Sep. 13, 2010

Related U.S. Application Data
(60) Provisional application No. 61/241,728, filed on Sep. 11, 2009.

(51) Int. Cl. H01S 3/091

(52) U.S. Cl. 372/71

(57) ABSTRACT

Output beam from laser diode bar (1) has divergence around 40 degrees along the fast axis and around 12 degrees along the slow one. The quality of such a beam along the fast axis is good and fast axis collimating lens (FAC) (2) can compensate its high divergence down to 0.5-1 degrees. In the direction of the slow axis the beam from the laser diode bar is focused by cylindrical lens (3) onto the pumping face of laser active medium (5). The pumping face is wider than the pumping spot on it to ensure efficient collection of pumping light. Laser active medium has two parallel faces which form a waveguide for the pumping light. As a result, the pumping light is confined within the waveguide along the slow-axis direction and collimated (near parallel) in the fast-axis direction. Therefore, length of the pump volume (6) can be as long as the laser element itself.

### CROSS-REFERENCE TO RELATED APPLICATIONS

This application claims the benefit of priority to U.S. Provisional Application No. 61/241,728 filed on Sep. 11, 2009, all of which application is incorporated herein by reference in its entirety for all purposes.

### TECHNICAL FIELD

The present invention relates generally to solid-state lasers, and, more specifically, to solid-state lasers, amplifiers, and related laser optical devices that use waveguide propagation of pumping light in laser active media, as well as to methods relating thereto.

### BACKGROUND OF THE INVENTION

Diode-pumped solid state lasers often offer superior performance in many applications, compared to other laser types. Output power of these lasers covers a wide range from milliwatts to multi-kilowatt levels. Lasers with output power up to several watts are usually pumped with a single-strip laser diode. Unfortunately, single-strip diode lasers are limited in output power. Higher pumping powers require using laser diode bars and stacks.

There are many optical schemes for pumping solid-state lasers. Most of these optical schemes can be divided into two groups: side-pumped and end-pumped. Side-pump layout is often found in high-power lasers where laser diode bars and stacks may be required for pumping. This approach, however, has several problems. In side-pumped configuration the pumping and the laser light propagate in orthogonal directions within the laser medium. The pumping light is mainly absorbed within a short distance from the pumping face and maximal inversion population is created on the pumping surface, whereas the laser mode mainly occupies a central part of the laser element. As a result, overlapping of the laser mode and the pumped volume is imperfect, giving rise to reduce efficiency of laser action.

Side pump layout cannot produce a uniform distribution of pump intensity across the laser element because the intensity of pumping light is attenuated exponentially. Non-uniform distribution of the pump light leads to thermal stress in the laser element and to distortion of the laser beam.

A zig-zag slab geometry where the laser beam follows a zig-zag path through the gain medium (U.S. Pat. No. 4,894,839) makes optical path length uniform across the laser beam aperture and provides some compensation of the thermal lens. It also solves a problem of pump volume and laser mode overlapping. Nevertheless, the zig-zag slab geometry falls short of extracting the pump energy from some regions in the laser crystal. This issue reduces the power efficiency of lasers.

Absorption bands of a side-pumped laser element with slab or rod geometry should be strong enough to absorb the pump light within the thickness of the laser element. But a short absorption length inevitably leads to high thermal stress. Absorption length may be increased when pumping light is directed along the laser element. This problem was solved partly by Ireland in U.S. Pat. No. 5,048,044 where the side walls reflect pumping light partly along the optical axis of the laser element.

Another solution is to use a laser element with high absorption and grazing-incidence slab laser geometry (U.S. Pat. No. 5,315,612). In this geometry the pump light of a laser diode bar is focused by a cylindrical lens onto a face of the laser crystal. The pumping light is highly absorbed, that's why population inversion is created only within a thin layer next to the pumping face. Grazing incidence angle of the laser beam and total internal reflection from the pumping face ensure a high degree of overlap between the laser mode and the pumped volume. This configuration offers high efficiency of laser operation, but also suffers from another problem. The thermal lens is compensated in one direction due to a total internal reflection, however in the orthogonal direction strong thermal lens remains uncompensated. The laser cavity may even become unstable when pump power is changed.

Due to the absorption length limit and temperature drift of the laser diode output wavelength, most side-pumped laser devices require precise temperature control of the laser diode bar in order to keep the emission wavelength aligned to the maximum of an absorption band.

In comparison to side-pump layout, end pumping is the most efficient method, best for pumping with single-emitter laser diodes because the pumping beam can be collimated within a small volume. The pumping beam overlaps the laser mode perfectly, providing highly efficient laser operation. Conversion efficiency of end pumping may be close to the theoretical limit. In spite of this, power limitation of single-emitter laser diodes remains a serious disadvantage of the end-pumping approach.

Higher-power lasers require multiple-diode bars for pumping. Laser diode bars are arrays of single-emitter laser diodes with directional diagram typically 40-50° along the fast-axis and 10-12° along the slow-axis directions. End-pumping method requires good pumping beam quality. Additionally, complicated and expensive optical elements must be used for beam profile correction. These elements also introduce power losses. These drawbacks constitute a strong limitation to wide practical application of laser diode bar end-pumped lasers.

Accordingly, there is still a need in the art for new and improved solid-state lasers, amplifiers, and related optical devices, as well as to methods relating thereto. The present invention fulfills these needs and provides for further related advantages.

### SUMMARY OF THE INVENTION

End-pumping of solid state lasers provides high efficiency due to excellent overlapping of the laser mode and the pumping beam. However, this method does not scale well into high output powers because single-emitter laser diodes used for pumping are power-limited. More powerful laser diode bars are assembled from separate laser diodes into a uni-dimensional array, thereby making good overlapping between the pumping beam and the laser mode difficult. End-pumping requires good pumping beam profile, which is possible to make, but beam shaping optical elements are expensive and introduce noticeable losses of pumping power. These drawbacks constitute a strong limitation to wide practical application of lasers end-pumped with laser diode bars.

The present invention proposes a new method of end pumping solid-state lasers with laser-diode bars, which reduces the effect of separate light sources within the laser diode bar, as it does that of its slow-axis divergence. This method of end-pumping also does not require costly optical elements and features low intra-cavity loss, thereby allowing efficient frequency conversion. The essence of this invention is explained as follows on one example of many possible embodiments.

Output beam from laser diode bar (1) has divergence around 40 degrees along the fast axis and around 12 degrees along the slow one. The quality of such a beam along the fast axis is good and fast axis collimating lens (FAC) (2) can compensate its high divergence down to 0.5-1 degrees. In the direction of the slow axis the beam from the laser diode bar is focused by cylindrical lens (3) onto the pumping face of laser active medium (5). The pumping face is wider than the pumping spot on it to ensure efficient collection of pumping light. Laser active medium has two parallel faces which form a waveguide for the pumping light. As a result, the pumping light is confined within the waveguide along the slow-axis direction and collimated (near parallel) in the fast-axis direction. Therefore, length of the pump volume (6) can be as long as the laser element itself. This guarantees complete absorption of the pumping light even with low active ion concentration or in case of weak absorption bands of the active medium.

This method is applicable to any active material, including well-known ones, such as YAG, YVO₄, YLF, and others. Besides laser oscillators it can also be used in laser amplifiers or laser oscillators where the laser cavity is formed by high-reflectivity mirror (4) and output-coupling mirror (7).

An object of this invention is a new method of end-pumping active media of lasers and amplifiers by means of semiconductor laser diode bars or stacks. The essence of this invention can be explained as follows on the example of its simplest variant.

Laser diode bars emit a beam with high quality along the fast-axis direction; therefore, a well-collimated (practically parallel) beam or a tight pump beam waist can be formed easily. In the slow-axis direction laser diode bar consists of multiple independent light sources with certain divergence. An optical element, such as a cylindrical or spherical lens, mirror, or their combination is used to focus the pump beam in the slow-axis direction onto a spot on the face of the active element. In the simplest form of this optical element, a single cylindrical lens or two inclined mirrors may be used. The slow-axis dimension of the pumping spot depends on the focal length of the cylindrical lens and may be very small when short-focus cylindrical lens is used. The corresponding dimension of the pump face of the active element slightly exceeds that of the pumping spot to ensure full collection of pumping light into the active element. The active element has two polished surfaces parallel to each other, which form a uni-dimensional waveguide for pumping light. Waveguide propagation mixes pumping light along the slow axis and makes its distribution uniform in this direction.

Thus, pumped volume within the laser element occupies the width of the active element in the slow-axis direction and the thickness of parallel or focused beam in the fast-axis direction. Since the pumping beam is well collimated in the fast-axis direction and confined by the waveguide in the slow-axis direction, the pumped volume may be relatively long. The length of the pumped volume may reach that of the active element, thereby offering an advantage over the conventional end-pumping where efficient laser operation is only possible close to the pump beam waist.

This method allows using laser materials with low concentration of laser ions in order to reduce thermal loading, achieve efficient pump absorption within wide spectral ranges, and to relax requirements on laser diode bar parameters. The proposed method of pumping does not require expensive components, at the same time providing means of efficient end pumping for high-power lasers, optical amplifiers, or other similar optical devices with optical gain.

These and other aspects of the present invention will become more evident upon reference to the following detailed description and attached drawings. It is to be understood, however, that various changes, alterations, and substitutions may be made to the specific embodiments disclosed herein without departing from their essential spirit and scope. In addition, it is expressly provided that all of the various references cited herein are incorporated herein by reference in their entireties for all purposes.

### BRIEF DESCRIPTION OF THE DRAWINGS

The drawings are intended to be illustrative and symbolic representations of certain exemplary embodiments of the present invention. For purposes of clarity, like reference numerals have been used to designate like features throughout the several views of the drawings.

FIG. 1 is an isometric view of an optical emission diagram of a laser diode bar in accordance with the prior art.

FIG. 2A is a top view of an optical layout associated with a method of pump light waveguide propagation.

FIG. 2B is a side view of optical layout associated with a method of pump light waveguide propagation where fast-axis divergence is collimated by FAC lens.

FIG. 2C is a side view of optical layout associated with a method of pump light waveguide propagation where additional lens and FAC lens form a pump beam waist in the laser medium.

FIG. 2D is a top view of optical layout where two mirrors instead of a slow-axis cylindrical lens are used to guide light into the active element.

FIG. 2E is a top view of optical layout where two mirrors are used in addition to the slow-axis lens to reduce loss of pumping energy because of large-angle emission.

FIG. 2F is a top view of optical layout in which a solid trapezoid optical element is used instead of two mirrors.

FIG. 2G is a top view of optical layout in which slow-axis lens is combined with trapezoid light concentrator in one solid optical element.

FIG. 3A is a top view of the laser element with pump light waveguide propagation having angle α between the pumping and the waveguide faces and showing a left side incidence.

FIG. 3B is a top view of the laser element with pump light waveguide propagation having angle α between the pumping and the waveguide faces and showing a right side incidence.

FIG. 4 is a diagram of the waveguide acceptance angle θₗ and θᵣ as a function of material refractive index for Brewster-angle cut of the active element.

FIG. 5A is a top view of the laser element with pump light waveguide propagation having Brewster angle between the pumping and the waveguide faces and showing single-sided pumping.

FIG. 5B is a top view of the laser element with pump light waveguide propagation having Brewster angle between the pumping and the waveguide faces and showing double-sided pumping.

FIG. 6A is a top view of the laser element with pump light waveguide propagation having a 45-degree angle between the pumping and the waveguide faces and showing single-sided pumping.

FIG. 6B is a top view of the laser element with pump light waveguide propagation having a 45-degree angle between the pumping and the waveguide faces and showing double-sided pumping.

FIG. 7 is a top view of the laser element with pump light waveguide propagation having a 45-degree angle between the pumping and the waveguide faces and with waveguide propagation of the laser beam.

FIG. 8A is a top view of the composite laser element with pump light waveguide propagation. Only slow-axis collimation lens with an optional light guide is shown, but any of the possible combinations discussed earlier can be used here.

FIG. 8B is an end section view of the composite laser element (1, 2), laser mode (3), and pumping volume (4).

FIG. 8C is a top view of the composite laser element with re-distribution of pumping light intensity.

FIG. 8D is a top view of the composite laser element where laser material pumped trough inactive optical material.

FIG. 8E is a top view of the composite laser element where laser material is sandwiched between two inactive optical layers.

FIG. 8F is a top view of the composite laser element with waveguide propagation of the laser mode through the active layer, whereas the pumping light is guided within the outer faces of the composite laser element.

FIG. 9A is a laser element with one inclined total-internal-reflection side;

FIG. 9B is a symmetrical laser element with two inclined total-internal-reflection sides;

FIG. 9C is a section view of composite laser element, laser mode, and pumping volume.

FIG. 10 is a top view of the laser element with multi-pass propagation of laser beam trough laser element.

FIG. 11 is a top and side view of laser experiment setup with pump light waveguide propagation.

FIG. 12 is a diagram of the output laser power vs. the laser diode pump power for output mirror reflectivity R=98, 90, 80, and 50%.

FIG. 13 is a diagram of the output laser power vs. the temperature of the laser diode bar operating at fixed current 25 A.

FIG. 14 is a diagram of the statistic distribution of the laser output power for 7,200 measurements during 2 hours.

### DETAILED DESCRIPTION OF THE INVENTION

End pumping method provides excellent spatial overlap between the focused pumping and the laser beams. High efficiency of laser operation according to this method has been demonstrated at power levels of several watts. Unfortunately, single laser diodes are limited in output power and higher power levels are only achievable with laser-diode bars and stacks.

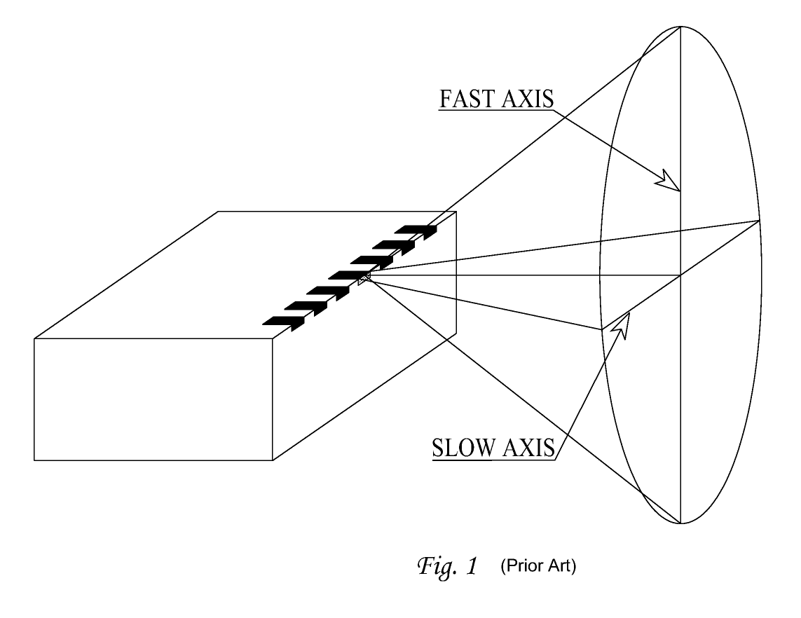

Diode bars consist of one-dimensional array of separate laser diodes. Each laser diode in the bar is a separate source of the light with divergence around 40-50 degrees along the fast axis and 10-12 degrees along the slow one (FIG. 1). Because the array is uni-dimensional, it is easy to compensate for the fast-axis divergence with a lens for all laser diodes. On the contrary, the slow-axis divergence compensation requires complicated and expensive optical components. This is a serious limitation of end-pumping technique for high-power laser applications.

The present invention provides a method of highly effective end pumping of laser material by conventional laser-diode bar and optical components.

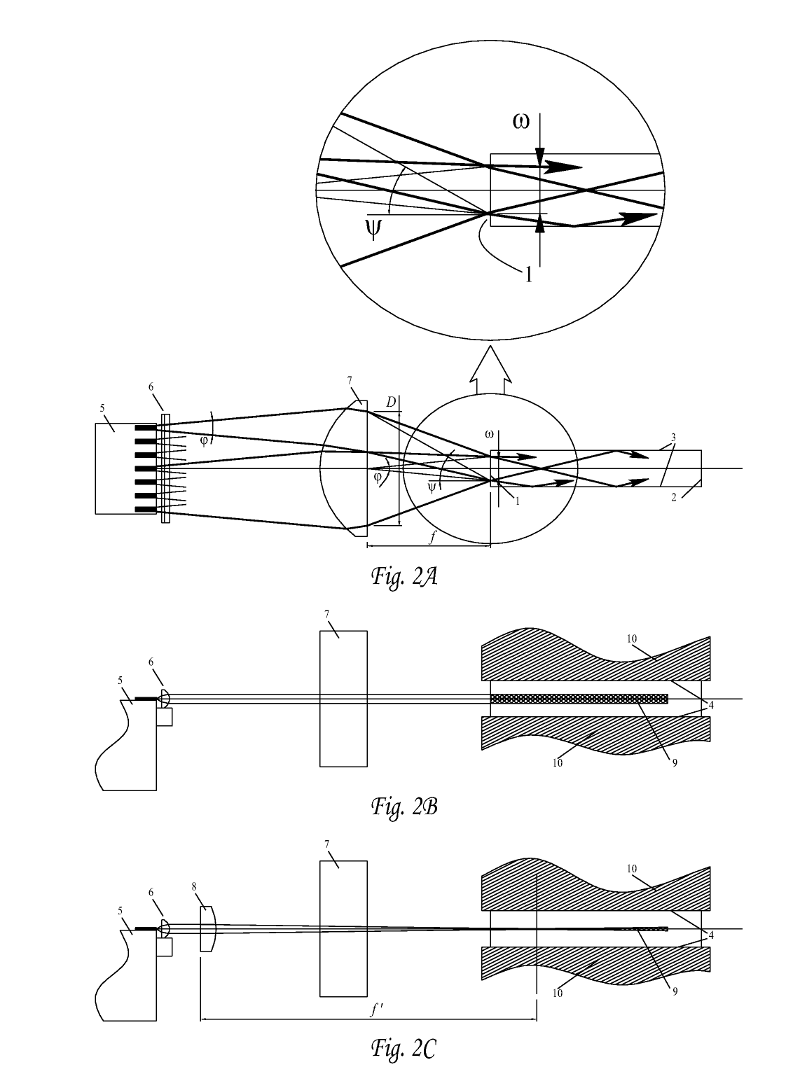

The essence of invention can be explained on the example of a rectangular laser element (FIGS. 2a, 2b, and 2c), however other shapes of the active element are also possible.

We will assume that all optical components have proper antireflection coating and the laser mirror on the pumping face of laser element has high transmission for pumping light. Thus, Fresnel reflections from all optical components can be ignored.

The front side of laser element (1) (FIG. 2a) is used for pumping and has low reflectivity at the pumping wavelength and high reflectivity for the laser emission wavelength. Its opposite side (2) may have antireflection coating if an external mirror is used for output coupling or if it is has a reflective coating with partial reflectivity. Two side faces (3) of the laser element have optical-quality surface finish, are parallel to each other and constitute a waveguide for the pumping light. Top and bottom sides (4) (FIG. 2b and FIG. 2c) of the laser element are connected with heatsink (9) and used for heat removal.

Pump light from laser diode bar (5) is first collimated along the fast axis by FAC lens (6), then focused in the direction of the slow axis by cylindrical lens (7). Cylindrical lens is oriented so that it collimates the pumping beam only in the slow-axis direction, it is wider than the laser-diode bar in order to collect all pumping light. The pumping beam has its highest intensity in the focal plane of the cylindrical lens, this is where the pumping face of the laser element is placed.

The cylindrical lens collimates the pumping beam onto a spot on the pumping face of the laser element. Since the cylindrical lens does not affect beam parameters in the direction of the fast axis, this dimension of the pumping beam is determined by FAC lens (6) (FIG. 2b). It is also possible to create a pump beam waist in the fast-axis direction by additional cylindrical or spherical lens (8) to increase pumping intensity within the pumped volume (9) (FIG. 2c).

Thus, the pumping beam in the direction of the fast axis has close to normal angle of incidence onto the pumping face and its dimension can be controlled by additional optical components.

As for the slow-axis direction, the spot size of the pumping beam in the focal plane of the lens is equal to:

ψ=2f tan(φ/2), (1)

where f is the focal length of the cylindrical lens and φ is the slow-axis divergence of the laser diode bar.

The pumping beam in focal plane of the lens contains a wide spectrum of incidence angles within the range (−ψ, +ψ):

$$ψ = arctan \frac{D + ω}{2 f} , \qquad ( 2 )$$

where D is the width of the pumping beam on the cylindrical lens.

To ensure high pumping efficiency, the laser element must be wider than the pumping spot on its face to collect all pumping light and all spectrum of incidence angles (−ψ, +ψ) must be within acceptance angle θ of the waveguide.

Acceptance angle θ for this waveguide is determined only by the refractive index of the laser material:

θ=arcsin\sqrt{n²−1}, (3)

where n is the refractive index of the laser material.

If the acceptance angle of the waveguide equals 90° then all incident light enters the waveguide.

According to formula (3), the acceptance angle for rectangular geometry of the laser element is 90° if refractive index of the laser material n>\sqrt{2}≈1.41. Most laser materials satisfy this requirement. Thus, the pumping light in this geometry of laser element can enter into the waveguide trough the pumping face without significant losses at any angle of incidence.

Since even at the optimum focal length the slow-axis lens may not focus all of the light from the diode bar, certain amount of energy is lost. According to experiments and estimations, the amount of this loss may be as high as 10-15%. In order to improve the laser efficiency by collecting this otherwise lost pumping light it is possible to use an additional element, a light concentrator or a light guide either in the shape of a trapezoid solid block (in which case it may rely on total internal reflection, see (12) in FIG. 20 or as two inclined mirrors as (11) in FIG. 2e. This light concentrator will reflect the part of the diode bar emission that would otherwise miss the aperture of the laser element back and ensure that this energy also enters the laser element and is used to create population inversion. This light guide may also be combined with the slow-axis lens to form a single element as (13) in FIG. 2g. In any of these cases the size and focal length of the slow-axis cylindrical lens is preferably chosen to minimise the amount of light from the diode bar that will be bent by the light concentrator.

In certain cases depending on the length and other parameters of the diode bar and/or the laser element it is possible to use the light concentrator alone without the slow-axis lens, for instance as (11) in FIG. 2d, in order to simplify the configuration.

In the waveguide pumping geometry the beam is confined between waveguide sides of laser element in the slow-axis direction. In the other direction the beam has high quality and can be made optically collimated over a long distance. This gives a possibility to increase the length of the pumped volume up to length of laser element. In this case it is possible to use for pumping even laser materials with weak absorption.

It is known that the output wavelength of the laser diode depends on temperature of its p-n transition and drifts by approximately 0.3 nm/C.° into longer wavelengths as the laser diode is heated. The absorption band of the laser material includes several peaks. Change in the laser diode temperature in waveguide pumping geometry results in a shift of the pumping wavelength and change in the pumped volume length. As long as the laser element is longer than the maximal length of the pumped volume, the pump light is absorbed efficiently in a wide range of laser diode bar temperatures. This relaxes requirements for laser diode bar temperature stabilization. In waveguide pumping geometry it is not necessary to keep pumping wavelength close to maximal absorption, and therefore possible to select optimal temperature for laser diode bar operation.

Heat from the laser element flows through top and bottom faces (9), which run parallel to the pumped volume. Since the width of the pumped volume equals the width of the laser element and the pumped volume may be long, this geometry reduces thermal load on the laser element and allows operating efficiently at high pumping power.

From this point of view, the concentration of laser ions should not be too high. Otherwise, the absorption length may become too short and thermal loading will not be spread evenly along the laser element.

Waveguide propagation mixes the pumping light along the slow axis and makes pumping distribution uniform in this direction. In the fast-axis direction the pumping beam has high quality and can be collimated optically into a thin beam waist. The pumped volume has uneven pumping intensity distribution along the laser element owing to exponential absorption of pumping light. But this has no effect on the laser beam quality because laser light also passes along nonuniformity of the pumped volume. So, this pumping geometry allows generation of high-quality laser beams or laser amplification without significant beam distortion.

In general case waveguide pumping geometry is applicable not only to rectangular laser elements but also to other laser element geometries as well. The pumping face can be cut at an angle to the waveguide faces of the laser element. However, in this case the acceptance angle of waveguide is different for left-(θₗ) and right-side (θᵣ) incidence.

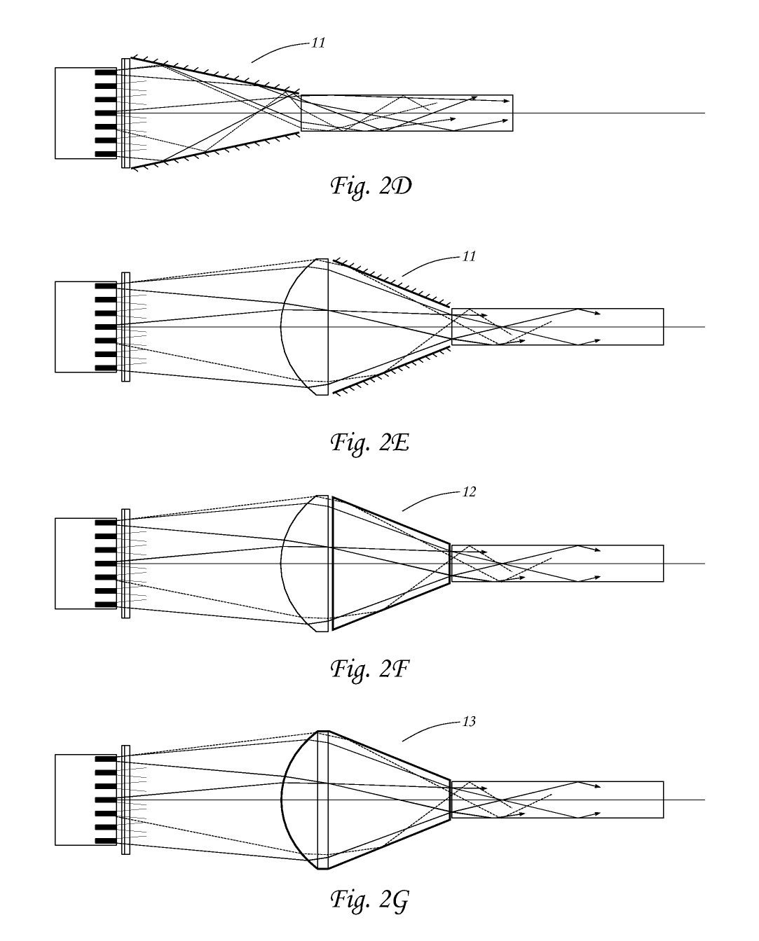

FIG. 3 shows beam propagation geometry in case of left-(FIG. 3a) and right-side (FIG. 3b) incidence. Let us first make calculations for the left-side incidence. α is the angle between the pumping face and waveguide side. The minimal angle of total internal reflection γ defined from Snell's law is:

$$sin γ = \frac{1}{n} . \qquad ( 4 )$$

We can determine β from triangle geometry:

β=α−γ. (5)

In accordance to the law of refraction:

sin θₗ=n sin β, (6)

Equations (4), (5), and (6) give us

$$sin {θ}_{l} = n sin ( α - arcsin \frac{1}{n} ) . \qquad ( 7 )$$

After simplification of Eq. (7), the value for maximal acceptance angle is:

θₗ=arcsin(sin α\sqrt{n²−1}−cos α). (8)

The same approach for the right-side incidence gives acceptance angle:

θᵣ=arcsin(sin α\sqrt{n²−1}+cos α). (9)

There is an important case when α is equal to the Brewster angle. According to Brewster's law:

α=arctan n. (10)

Using Eq. (8), (9), and (10) we will find that θₗ and θᵣ for Brewster angle-cut laser element are equal to:

$$\begin{matrix}{θ}_{l} = arcsin ( \frac{n \sqrt{{n}^{2} - 1} - 1}{\sqrt{{n}^{2} + 1}} ) ; & ( 11 ) \\ {θ}_{r} = arcsin ( \frac{n \sqrt{{n}^{2} - 1} + 1}{\sqrt{{n}^{2} + 1}} ) . & ( 12 )\end{matrix}$$

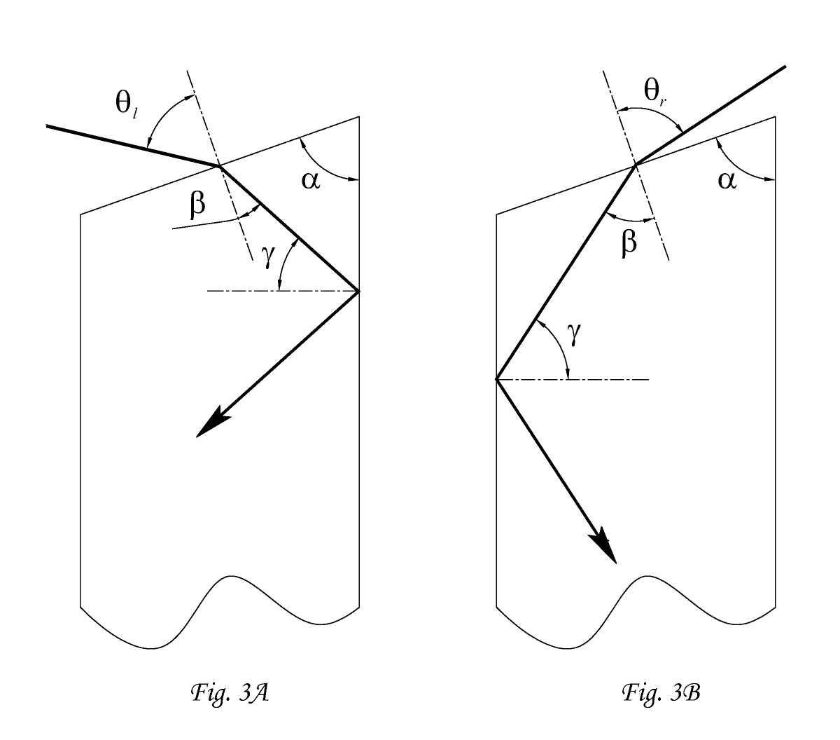

FIG. 4 shows dependence of θₗ and θᵣ upon n. Numerical calculation shows that the right-side incidence θᵣ>90° takes place if refractive index n>1.093. This requirement is met for all solid-state laser materials. Thus, for solid-state laser materials with Brewster angle cut acceptance angle is confined within sector θₗ−90°.

Brewster angle-cut laser elements offer several advantages over other configurations. Linearly polarized laser beam is refracted on passing through the pumping face without losses. The refracted beam propagates at angle α to the normal to the pumping face, thus giving the possibility to separate the laser and the pumping optical systems. This also makes it easier to guide the beam in amplification mode. Since the laser beam is stretched along the slow-axis direction, an oblique incidence angle will reduce the beam dimension in this direction, and therefore compensate for the beam asymmetry.

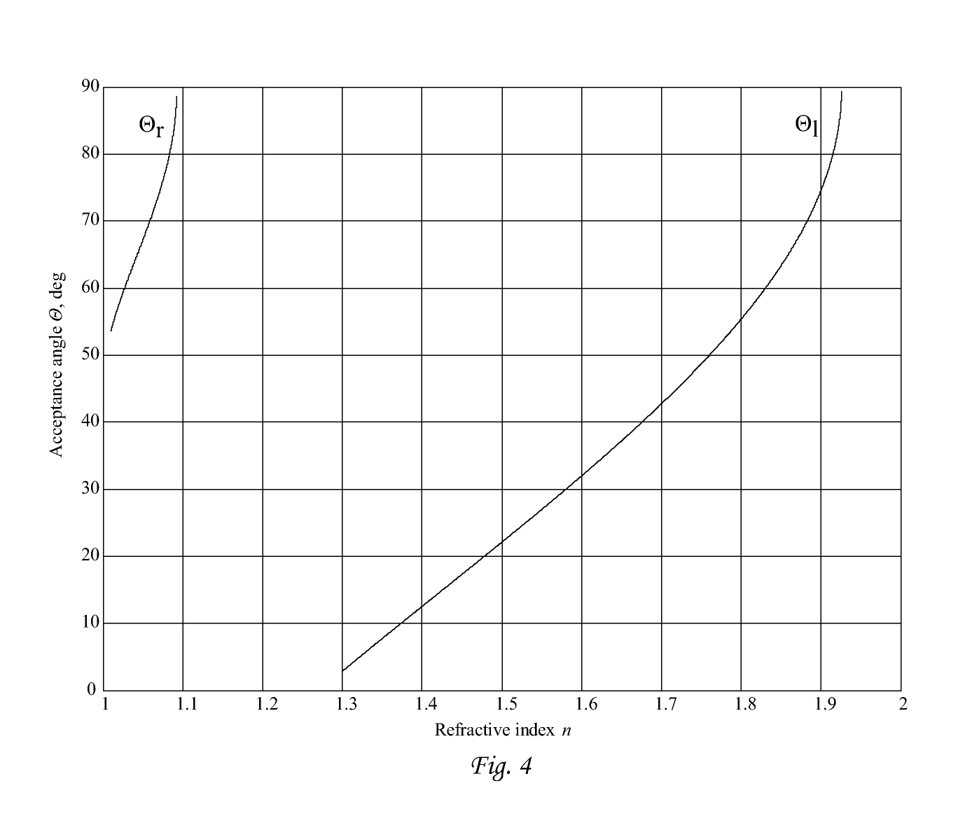

FIG. 5 shows some examples of possible configurations of waveguide propagation pumping with Brewster-cut laser elements. Shown in FIG. 5a is single-sided laser pumping layout. Due to refraction on the tilted face the laser beam has different dimensions on entrance into and exit from the laser element. Nevertheless, this layout is convenient for a laser oscillator, in which the laser cavity is formed by totally reflective and output mirrors (dotted lines on FIG. 5a and FIG. 5b).

Double-sided pumping shown in FIG. 5b provides a more powerful configuration. It does not change relative beam dimensions and offers a possibility to assemble several modules like the one given in FIG. 5b into a single optical unit to increase the output power.

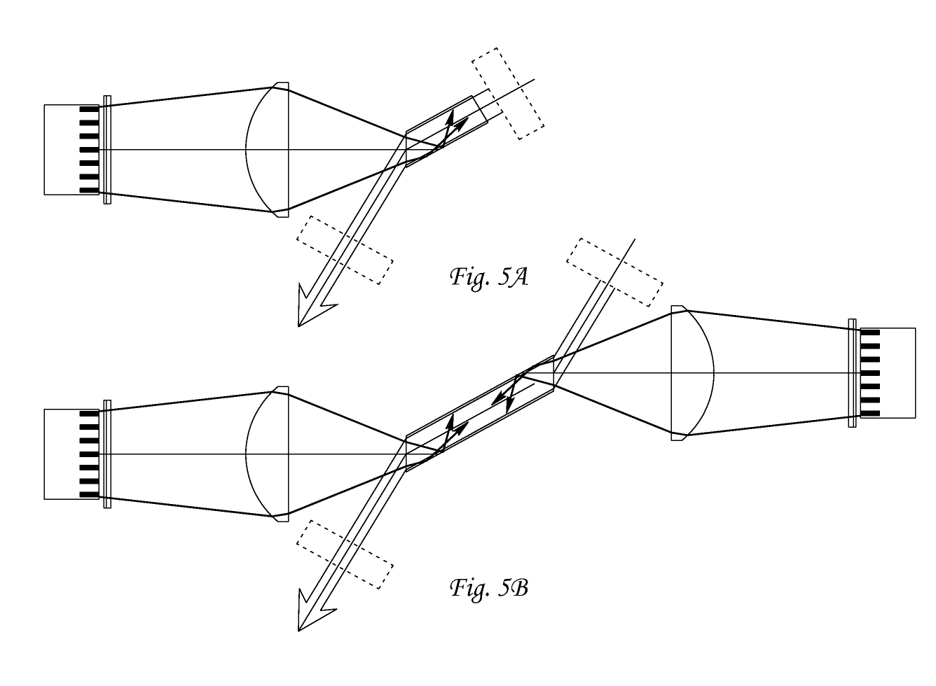

The pumping face can also be used for total internal reflection of the laser beam. In this case the laser beam enters through an adjacent face. FIG. 6a shows the configuration of one possible application with the laser element cut at α=45°. The laser material must have refractive index sufficient for total internal reflection of all incidence angles within the pumping beam. Double-side pumping is also possible to implement in this configuration (FIG. 6b).

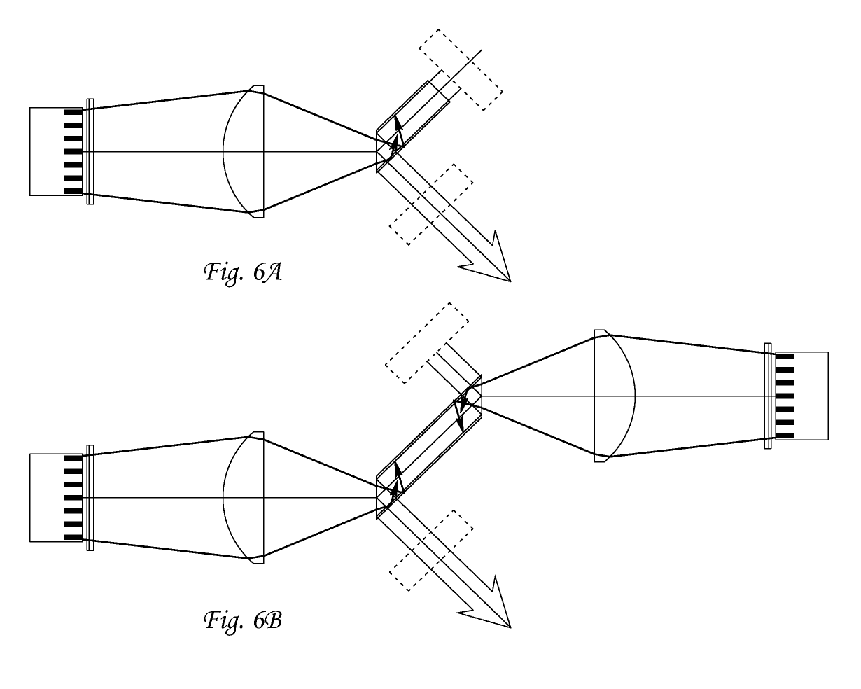

Waveguide propagation of pumping light gives a possibility to create a uniform distribution of excited ions across the laser element. But the value of the electrical field in the laser beam drops toward the waveguide faces. This is why in direct propagation of laser beam only the central part of the laser element participates in laser operation efficiently. Waveguide propagation of both laser beam as well as the pumping beam allows efficient utilization of the entire pumped volume in the lasing process. One of possible laser geometries with waveguide propagation of both the pumping and laser beams is shown in FIG. 7.

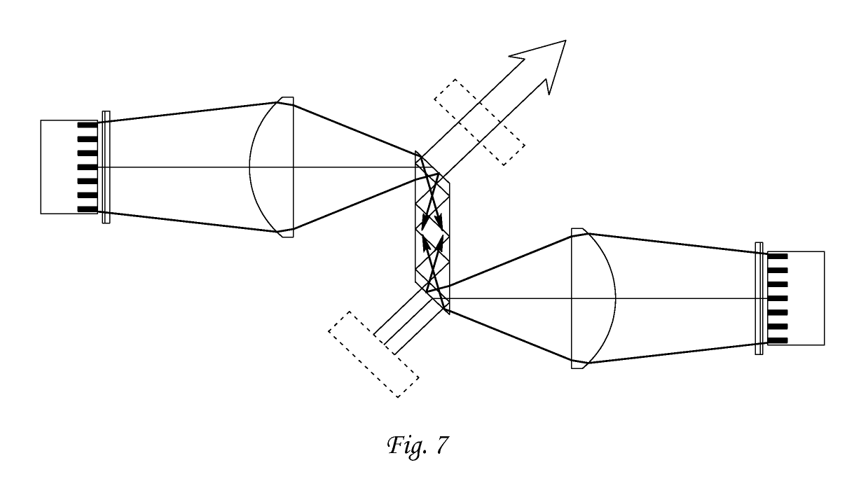

It may be desirable to use a composite laser element to create a waveguide for the light from pumping devices (FIG. 8a). Such composite laser element includes a layer of active laser material (1) and one or more layers of inactive optical material transparent for both laser radiation and pumping light (2). Either undoped host material (same as in the active layer) or a different optical material may be used. Inactive layer(s) has (have) four optical surfaces, one of which is in optical contact with one of the active layer's faces. This optical contact may be achieved either by mechanically holding the two layers together, by fixing them with an optical glue, diffusion bonding, or other suitable methods. The refractive index of inactive layer(s) must be equal to or lower than that of the active laser layer. Either the outer face of the active layer and that of the inactive layer, or outer faces of two inactive layers sandwiching the active layer form a waveguide for the pumping light. The thickness of the active laser layer may be chosen so as to match the size of the laser mode generated in the element (FIG. 8b) (3), whereas the pumped volume (4) fills the entire thickness of the composite laser element.

Outer faces of this waveguide may be flat and parallel to each other and to the faces of the active layer (which also may be parallel and flat). Alternatively, and in order to shape the distribution of the pumping light intensity along the laser element, irrespective of the shape of inner faces of the inactive layer(s) and hence, faces of the active layer, the outer faces of the composite laser element may be cut at an angle relative to the optical axis of the system (which may be also parallel to the faces of the active layer). Pumping light intensity may be further shaped or re-distributed by using non-flat outer faces of the composite laser element (FIG. 8c).

Inactive layer(s) and the active layer may form a single face used for guiding the pumping light into the element (FIG. 8 a, c). Alternatively, pumping may be also done only through the face(s) of inactive layers (FIG. 8d).

Optically connected surfaces of inactive layer(s) and the laser layer may be relatively large. Therefore it is possible to use them for efficient removal of heat generated inside the active layer by the laser action, provided that thermal conductivity of the inactive layer(s) is chosen sufficiently high. In such case a composite laser element sandwiched between two inactive optical layers can be used specifically to make the temperature distribution within the active layer more symmetrical and uniform (FIG. 8e), as well as to ensure higher heat removal efficiency as compared to the configuration with only one inactive layer.

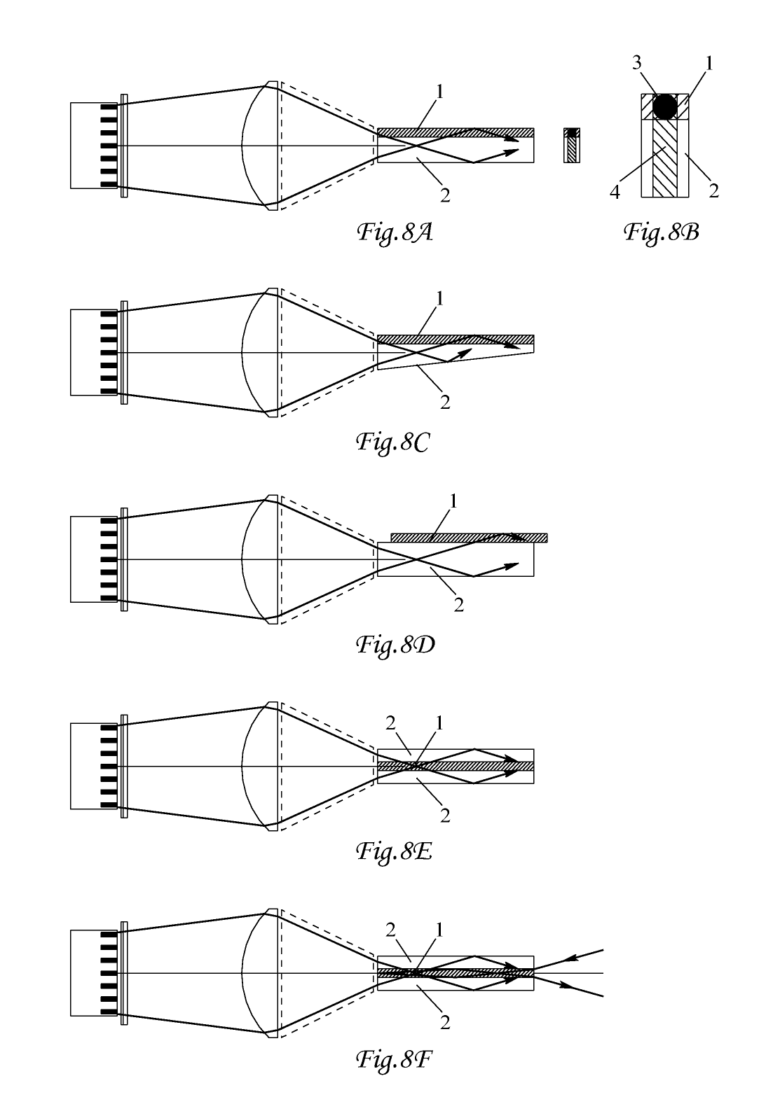

The refractive index of inactive layer(s) may be chosen sufficiently lower than that of the active laser material to ensure total internal reflection of the laser mode from the interface between the active layer and the inactive one, thereby leading to waveguide propagation of the laser mode through the active layer, whereas the pumping light is guided within the outer faces of the composite laser element (FIG. 8f). In all modifications of the pumping layout of FIG. 8a-f a light concentrator discussed earlier may be used (shown in dashed lines on an example of a separate from slow-axis lens solid element). Depending on specific configuration of the laser elements it may be possible to further simplify the layout and use a laser element tapered on one or both sides as shown in FIG. 9a-c. The laser cavity in this case would be defined by reflective coating(s) deposited directly on the laser element or external (dichroic) mirrors through which pumping is done.

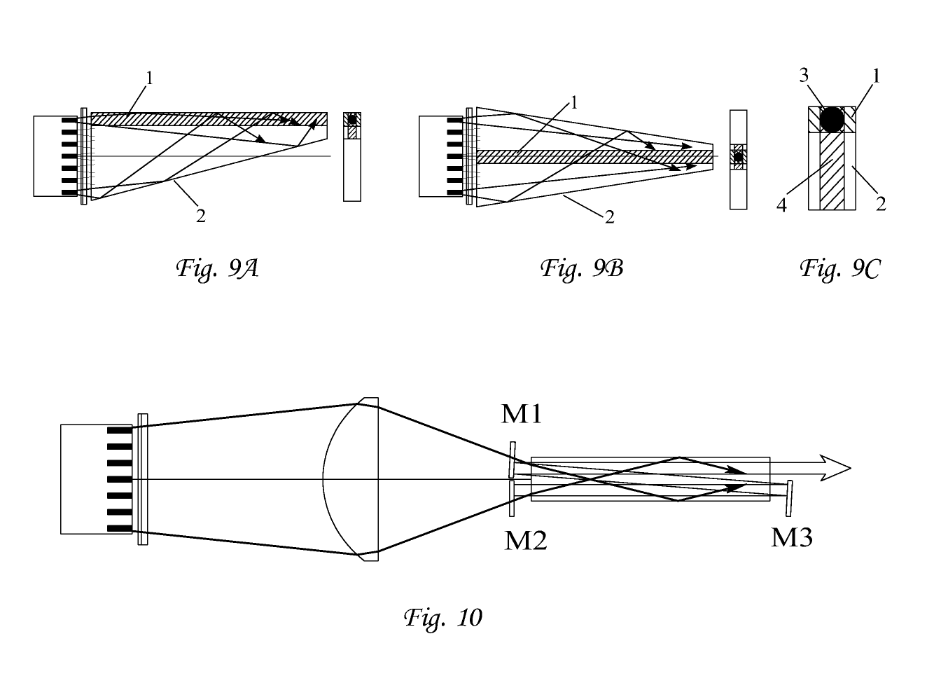

Some laser applications require high gain. Larger laser element aperture readily allows multi-pass propagation of laser beam trough the laser element. A three-pass laser system is shown in FIG. 10 for illustration.

For purposes of illustration and not limitation, the following examples and test results more specifically discloses exemplary process steps and actual experimental data associated with the solid state laser systems of the present invention.

### Test Results

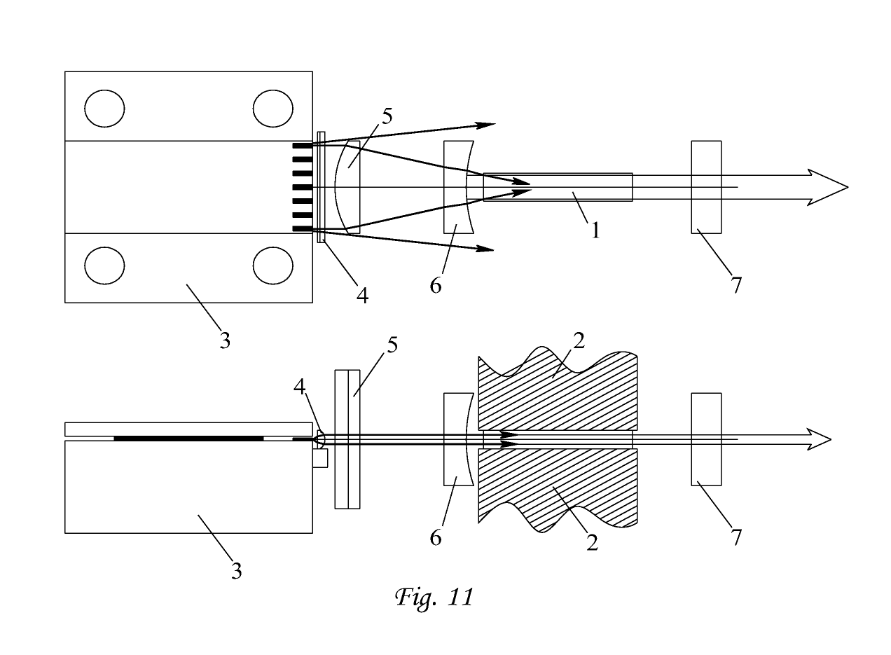

Laser experiments for proof of the present invention where conducted on the example of a laser oscillator (FIG. 11).

A rectangular Nd:GdVO₄ crystal doped with 0.2% Nd served as the laser element (1). Its dimensions were 2×3×15 mm. The two 2×15-mm faces were polished and formed a waveguide for pumping light. The 3×15-mm faces were ground and used for heat removal. The laser element was sandwiched between two copper blocks (2). Indium foil was used between the laser element and copper blocks to reduce mechanical stress. The temperature of the copper blocks was controlled by thermoelectric cooling system to accuracy of 0.1° C.

Pumping was done through the 2×3-mm faces. Both faces were antireflection-coated for the laser wavelength and slightly inclined by 0.5 degrees to prevent parasitic oscillations.

The laser element was pumped by a 10-mm long 40-W, 808-nm CW laser-diode bar (3) (LASERTEL model 1210) assembled with a fast-axis collimation (FAC) lens (4). The temperature of the laser-diode bar was controlled by a thermoelectric cooling system with tolerance of 0.1° C.

The pump radiation was focused by a cylindrical lens (5) with f=12.5 mm in slow-axis direction onto the pumping face of the laser element. The cylindrical lens had antireflection coating for the pumping wavelength. The width of the lens was 10 mm which is equal to that of the laser-diode bar, and the lens was placed close to the laser-diode bar to fill its aperture. However, a small fraction of the pumping light still escaped.

A concave laser mirror (6) with radius 250 mm and high reflectivity at the laser wavelength was placed between the cylindrical lens and the pumping face of the laser element. This mirror had 96% transparency for the pumping light and was placed 1 mm apart from the active element's pumping face.

Thus, the pumping layout for this laser is very compact with distance between the laser-diode bar and the laser element only 17 mm.

A 22-m long laser cavity was formed by the above-mentioned totally reflective mirror and an interchangeable flat output couplers with different reflectivity (7).

The cylindrical lens collimates the pumping light on the pumping face into a 2.6-mm wide spot. FAC lens of the laser-diode bar formed in the fast-axis direction a close to parallel pumping beam. The pumping beam was not collimated in this direction and the short dimension of the spot was 0.5 mm.

### Experiment 1

Input and output parameters with different reflectivity of the output coupler were measured.

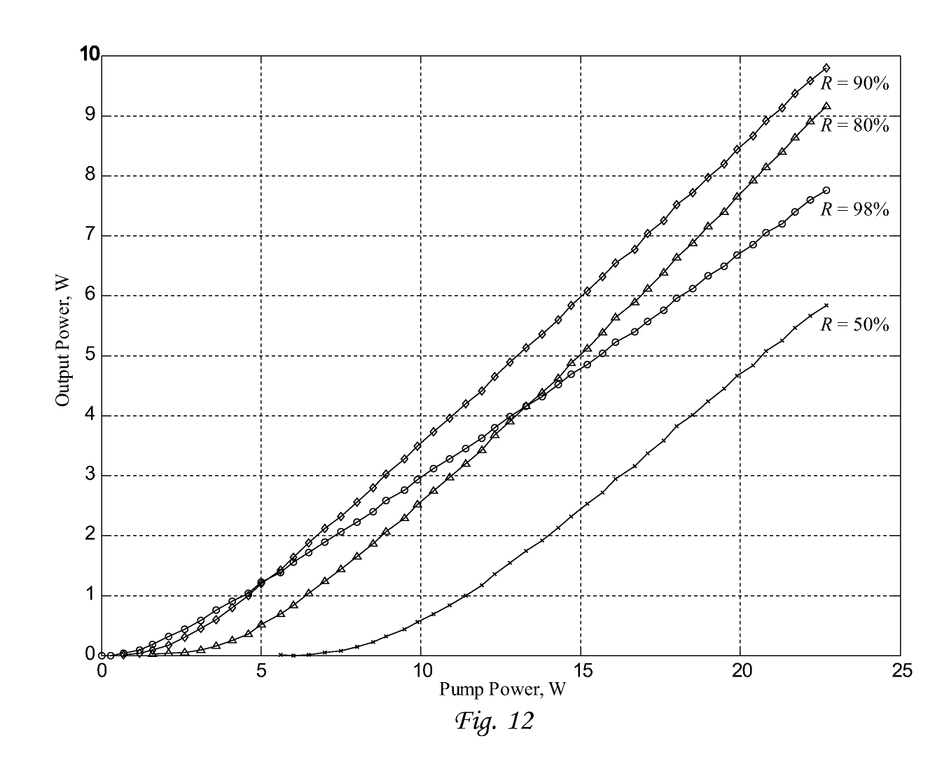

The output laser power vs. the laser diode pump power is shown in FIG. 12 for output mirror reflectivity R=98, 90, 80, and 50%.

Laser mirror with R=90% allows the most efficient operation at 1063-nm wavelength. The absolute efficiency was calculated to equal 43.2% and the differential efficiency was 48.4%.

Maximal laser output was 9.8 W at pumping power 22.7 W. Threshold of the laser operation was measured to be 920 mW.

The absolute efficiency, slope efficiency, and the threshold power for different coupling mirrors are summarized in Table. 1.

TABLE 1

| | R = 98% | R = 90% | R = 80% | R = 50% |
|---|---|---|---|---|
| Slope Efficiency, % | 36.88 | 48.39 | 51.09 | 43.08 |
| Absolute Efficiency, % | 34.19 | 43.17 | 40.35 | 26.21 |
| Threshold, mW | 50 | 920 | 1860 | 5800 |

The intra-cavity losses were measured from the input-output characteristics of the laser. A method for calculation of intra-cavity losses based on the slope efficiency with different reflectivity of output mirrors is widely used.

This method can be briefly outlined as follows:

The slope efficiency of the laser can be found from the following expression:

$${η}_{diff} = k \frac{ln R}{𝓁 - ln R} , \qquad ( 13 )$$

Where k is a constant including the Stokes shift, pumping efficiency, etc.;

l—two pass intra-cavity losses;

R—output mirror reflectivity.

For two mirrors with corresponding reflectivities R₁ and R₂ we have:

$${η}_{diff}^{′} = k \frac{ln {R}_{1}}{𝓁 - ln {R}_{1}} , and {η}_{diff}^{″} = k \frac{ln {R}_{2}}{𝓁 - ln {R}_{2}} , \qquad ( 14 )$$

Further from Eq. (14) follows:

$$\frac{{η}_{diff}^{′}}{{η}_{diff}^{″}} = \frac{ln {R}_{1}}{ln {R}_{2}} \frac{𝓁 - ln {R}_{2}}{𝓁 - ln {R}_{1}} . \qquad ( 15 )$$

The value of l can be found from Eq. (15) as:

$$𝓁 = \frac{ln {R}_{1} ( 1 - X )}{Y - X} , \qquad ( 16 )$$

Where X=η_{diff}′/η_{diff}″, and Y=lnR₂/lnR₂.

For calculation of losses at 1063 nm reflectivity values R₁=98% and R₂=90% where selected for the output coupler because lasing efficiency with mirror R₁=98% is reduced due to high impact of intra-cavity losses compared to other mirrors. For calculations data from Table 1 were selected η_{diff}′=0.3688 and η_{diff}′=0.4839.

Using these data Eq. (4) gives value for double-pass intra-cavity losses at 1063 nm l=0.84%. This confirms that the suggested geometry of the laser element gives low value of inactivity losses.

### Experiment 2

The pumping light wavelength from the laser diode bar depends on the temperature of the bar and drifts by 0.3 nm per 1° C. Usually, it is necessary to control the temperature of the laser diode bar in order to adjust the emission spectrum for the best overlap with absorption bands of the laser medium.

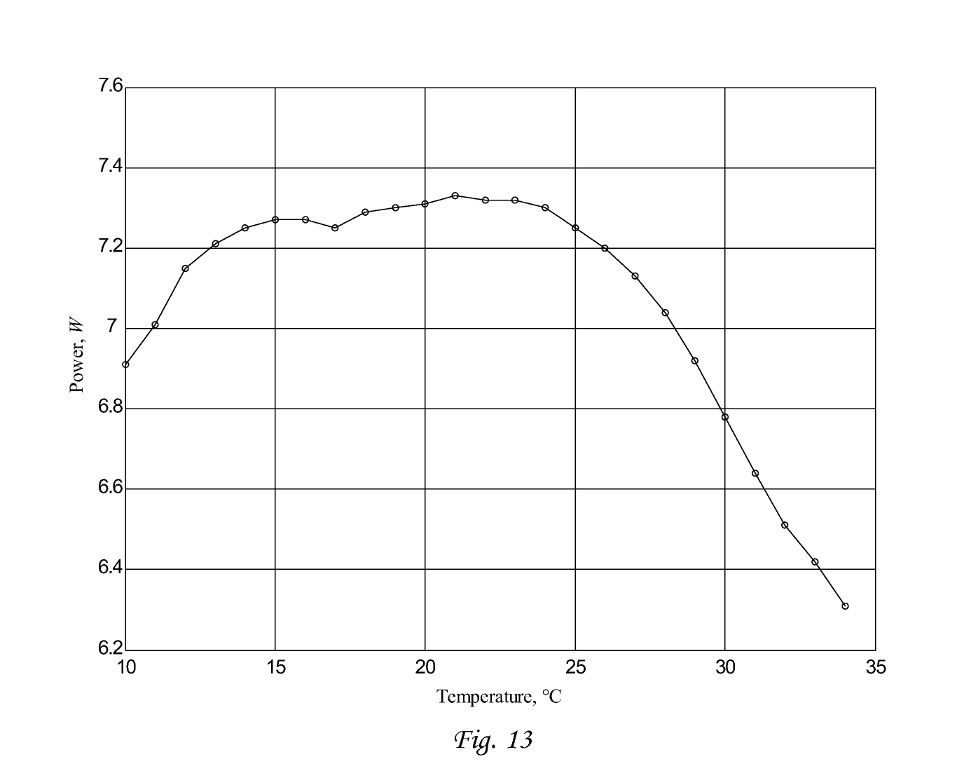

Waveguide pumping geometry provides a long pumping area and is not expected to exhibit strong dependence of laser operation efficiency upon the temperature of the laser diode bar. In this experiment, the output power of the laser was measured at fixed pump power 17.6 W. The output mirror was flat with reflectivity R=90%. The temperature of the laser diode bar was varied from 10° C. to 34° C. FIG. 13 shows the laser output power of vs. the laser diode bar temperature. The output power changed within the range 6.31 W to 7.33 W when temperature varied from 10° C. to 34° C. that gives stability 15%. In the range from 15° C. to 25° C. range the output power changes from 7.25 to 7.33 W, which corresponds to stability 1%.

Therefore, the waveguide pumping geometry does not need precise temperature control of the laser diode bar, moreover the laser diode bar temperature may be selected for optimal operating conditions of the laser diode bar.

### Experiment 3

Stability is an important parameter for the DPSS lasers. Thermal lensing in laser medium is the main source of laser operation instabilities. Long pumped volume of the waveguide pumping geometry also gives the advantage of lower thermal loading.

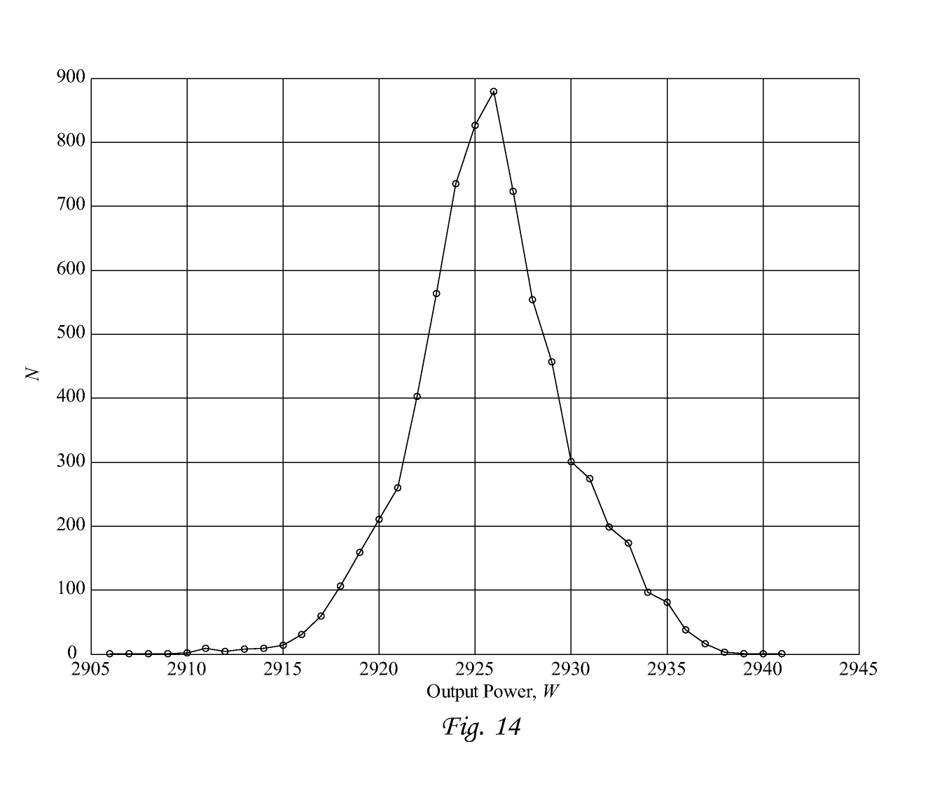

In this experiment, stability of laser operation was measured at fixed pump power 9.5 W. The laser diode temperature was 20° C. stabilised to within 1.5° C. The output power was recorded every second for the duration of 2 hours. Total of 7200 measurements were made. Statistic distribution of these measurements is shown in FIG. 14.

Arithmetic mean of this distribution is Pₘₑₐₙ=2,925.81 mW and the standard deviation σ=3.99 mW. This means that the laser stability for two hours of operation was σ/Pₘₑₐₙ=0.13%.

Repeated measurements within several days demonstrated the same output power within this statistic distribution.

In conclusion this method provides design of diode bar end pumped solid state lasers, amplifiers and other optical devices having high power operation, high efficiency, compact size, high temperature stability, high temporal stability.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A method of optical end pumping by use of laser diode bars or arrays to produce optical gain in laser material having at least two polished surfaces parallel to each other forming waveguide for pump light, comprising:
laser diode bars or arrays for generating the pump light which is collimated separately for slow-axis and fast-axis directions:
a collimation means for the fast-axis direction whereby the pump beam is collimated by a fast-axis collimating lens or its combination with additional optical elements, such as lenses and/or mirrors, for concentration of pump energy within the laser element in the fast-axis direction;
a collimation means for the for slow-axis direction whereby the pump beam is collimated by the optical system so as to ensure waveguide propagation of pump light through the laser element;
laser element oriented so that its waveguide surfaces are perpendicular to the slow-axis plane and ensure waveguide propagation along the laser element.

2. The method as recited in claim 1 wherein the pump face is perpendicular to both waveguide faces and slow-axis plane

3. The method as recited in claim 1 wherein the pump face is perpendicular to waveguide faces and tilted (not orthogonal) with respect to the slow-axis plane.

4. The method as recited in claim 1 wherein the pump face is cut at an angle to the waveguide faces including Brewster and 45-degree angles.

5. The method as recited in claim 1 wherein the laser light experiences a total internal reflection from the pumping face.

6. The method as recited in claim 1 wherein the pump light undergoes waveguide propagation after total internal reflection from a face of laser element.

7. The method as recited in claim 2 wherein a composite laser element is formed by laser material and inactive optical material with flat and parallel faces forming waveguide for pump light.

8. The method as recited in claim 2 wherein inactive optical material is either undoped laser host material or a different optical material and where the active optical material is YAG, YVO4, YLF, or other known solid-state laser material.

9. The method as recited in claim 2 wherein the laser element is a diffusion-bonded body.

10. The method as recited in claim 2 wherein composite laser element is formed by laser material having flat and parallel faces and inactive optical material with flat and non-parallel outer faces forming waveguide for pump light for re-distribution of pumping light intensity along the laser element.

11. The method as recited in claim 2 wherein composite laser element is formed by laser material and inactive material with non-flat outer faces for shaping the distribution of pumping light intensity within the laser element.

12. The method as recited in claim 2 wherein composite laser element is formed by laser material and inactive optical material with flat and parallel faces forming waveguide for pump light and pumping of laser element is realized only trough inactive optical material.

13. The method as recited in claim 2 wherein composite laser element is laser material sandwiched between two inactive optical layers.

14. The method as recited in claim 2 wherein total internal reflection of the laser mode from the interface between the active layer and the inactive one, thereby leading to waveguide propagation of the laser mode through the active layer, whereas the pumping light is guided within the outer faces of the composite laser element.

15. The method as recited in claim 7 wherein inactive optical material is thermally conductive body and contact with waveguide faces for heat removal.

16. The method as recited in claim 2 wherein a thermally conductive body which has high reflectivity for pump light providing waveguide propagation is in contact with waveguide faces for heat removal.

17. The method as recited in claim 2 wherein the pump face is also coated with a reflective coating or antireflection coating.

18. The method as recited in claim 2 wherein the lasing medium is pumped from two opposite sides in which the pump light propagates in opposite directions through the waveguide.

19. The method as recited in claim 2 wherein the laser mode undergoes one or more total internal reflections from a waveguide face.

20. The method as recited in claim 2 wherein the laser light undergoes multipass propagation in the laser element.

21. An end pumped solid-state laser, comprising:
an elongated optical waveguide having parallel lengthwise waveguide faces and a pumping face on at least one end;
a laser diode bar or stack pump light source for generating a pumping beam, the pumping beam having a slow-axis direction and a fast-axis direction perpendicular to the slow-axis direction, the pumping beam being optically waveguide; and
a cylindrical lens interposed between the laser diode bar or stack light source and the pumping face, the cylindrical lens being configured to collimate the slow-axis direction of the pumping beam onto a spot located on the pumping face.
